(19) United States
(12) Patent Application Publication
(10) Pub. No.: US 2014/0173733 A1
(43) Pub. Date: Jun. 19, 2014

(54) EXPLOIT DETECTION AND REPORTING OF A DEVICE USING SERVER CHAINING

(71) Applicant: Fixmo, Inc., (US)

(72) Inventor: Daniel Ford, Silver Spring, MD (US)

(73) Assignee: Fixmo, Inc., Toronto (CA)

(21) Appl. No.: 13/716,852

(22) Filed: Dec. 17, 2012

(51) Int. Cl. H04L 29/06

(52) U.S. Cl. CPC H04L 63/1416
USPC 726/23

(57) ABSTRACT

A server configured for managing server access by a first client application of a device over a communications network. The server receives a status message from the first client application over the communications network, the first client application managed by the server, the message including at least one compliance characteristic associated with a security policy of the server and an unique identification of the device. The server can access the security policy and compare the at least one compliance characteristic with a corresponding policy of the security policy to determine a current state of the device as contrary to the corresponding policy and in response generate a compromised status indicator for the device. The server can also access a storage to obtain a network address associated with a second server managing a second client application of the device and send a device status message to the network address of the second server including the compromised status indicator and identification data uniquely identifying the device to the second server.

### FIELD

The present invention relates to computer device security.

### BACKGROUND

Exploitation of computing devices is an ever increasing problem in today's mobile workforce environment. In particular, efficient and timely detection of exploited devices is commonly masked, due to various exploitation masking utilities and masking functionality of unauthorized applications present on the exploited device. Examples of exploitation include jail breaking and rooting of a device. iOS jail breaking is a process of removing device software and hardware limitations configured on Apple™ devices running the iOS operating system. Common jail break techniques include the use of software exploits, which can affect a number of popular consumer devices such as the iPhone, iPod touch, iPad, and second generation Apple TV. Of particular concern is that jail breaking permits root access to the iOS operating system, allowing the download of unauthorized applications, extensions, and themes that are unavailable through the official Apple App Store. Jail breaking can be referred to as a form of privilege escalation. It is noted that even though jail broken, the exploited can still use the a variety of web services and other normal device functions, all of which can remain unaware of the exploited status of the device. Unlike rooting an Android device, jail breaking is necessary if the user intends to run software not authorized by Apple.

Although jail breaking/rooting has been deemed acceptable from a legal standpoint in some countries, in those countries these exploited devices still have their security model removed. Therefore, enterprises that are security conscious, and are in communication with the exploited devices, typically are unaware of the exploited status of the device and are therefore at risk of having unauthorized access via the exploited device to their enterprise data. Further, device applications that have been created in unauthorized App stores (i.e. Cydia) have the capability to re-write commands for authorized Apps that are inspecting for jail breaking or rooting, so that device responses to any network service will always be that the device has not been jail broken or rooted.

Further, in the event of detection of a exploited status of a device in communication with one network service, other independent network services may not be aware of this exploited status (e.g. may not be able to detect or identify the exploited status via their network communications with the exploited device) and may therefore put the security of their enterprise data at risk.

### SUMMARY

An object of the present invention is to provide a server notification method to obviate or mitigate at least one of the above-presented disadvantages.

In the event of detection of a exploited status of a device in communication with one network service, other independent network services may not be aware of this exploited status (e.g. may not be able to detect or identify the exploited status via their network communications with the exploited device) and may therefore put the security of their enterprise data at risk. Contrary to current exploit detection schemes there is provided a server configured for managing server access by a first client application of a device over a communications network. The server has a set of stored instructions for execution by a computer processor to: receive a status message from the first client application over the communications network, the first client application managed by the server, the message including at least one compliance characteristic associated with a security policy of the server and an unique identification of the device. The server can access the security policy and compare the at least one compliance characteristic with a corresponding policy of the security policy to determine a current state of the device as contrary to the corresponding policy and in response generate a compromised status indicator for the device. The server can also access a storage to obtain a network address associated with a second server managing a second client application of the device and send a device status message to the network address of the second server including the compromised status indicator and identification data uniquely identifying the device to the second server.

A first aspect provided is a server configured for managing server access by a first client application of a device over a communications network, the server having a set of stored instructions for execution by a computer processor to: receive a status message from the first client application over the communications network, the first client application managed by the server, the message including at least one compliance characteristic associated with a security policy of the server and an unique identification of the device; access the security policy and compare the at least one compliance characteristic with a corresponding policy of the security policy to determine a current state of the device as contrary to the corresponding policy and in response generate a compromised status indicator for the device; access a storage to obtain a network address associated with a second server managing a second client application of the device; and send a device status message to the network address of the second server including the compromised status indicator and identification data uniquely identifying the device to the second server.

A second aspect provided is a server configured for managing server access by one or more client applications of a device over a communications network, the server having a set of stored instructions for execution by a computer processor to: receive a device status message over the communications network from a second server including a compromised status indicator and identification data uniquely identifying the device, the compromised status indicator indicative of a current state of the device as contrary to a security policy of the second server; and update in a storage a server access status of the device with the server in order to inhibit further server access by the device with the server until receipt of a restore status message indicating the current state is in compliance with the security policy.

### BRIEF DESCRIPTION OF THE DRAWINGS

The foregoing and other aspects will be more readily appreciated having reference to the drawings, wherein:

FIG. 1 is a perspective view of a network system;

FIG. 2 shows a further configuration example of the network system of FIG. 1;

FIG. 3 shows an example configuration of a device of the system of FIG. 1; and

FIG. 4 shows an example configuration of a server of the system of FIG. 1.

### DESCRIPTION

The claimed invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the claimed invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the claimed invention is provided below along with accompanying figures that illustrate the principles of the invention. The claimed invention is described in connection with such embodiments, but the claimed invention is not limited to any embodiment. The scope of the claimed invention is limited only by the claims and the claimed invention encompasses numerous alternatives, modifications and equivalents. Numerous specific details are set forth in the following description in order to provide a thorough understanding of the claimed invention. These details are provided for the purpose of example and the invention may be practiced according to the claims without some or all of these specific details. For the purpose of clarity, technical material that is known in the technical fields related to the claimed invention has not been described in detail so that the claimed invention is not unnecessarily obscured.

In this specification and in the claims, the use of the article “a”, “an”, or “the” in reference to an item is not intended to exclude the possibility of including a plurality of the item in some embodiments. It will be apparent to one skilled in the art in at least some instances in this specification and the attached claims that it would be possible to include a plurality of the item in at least some embodiments.

### Device and Server Environment 8

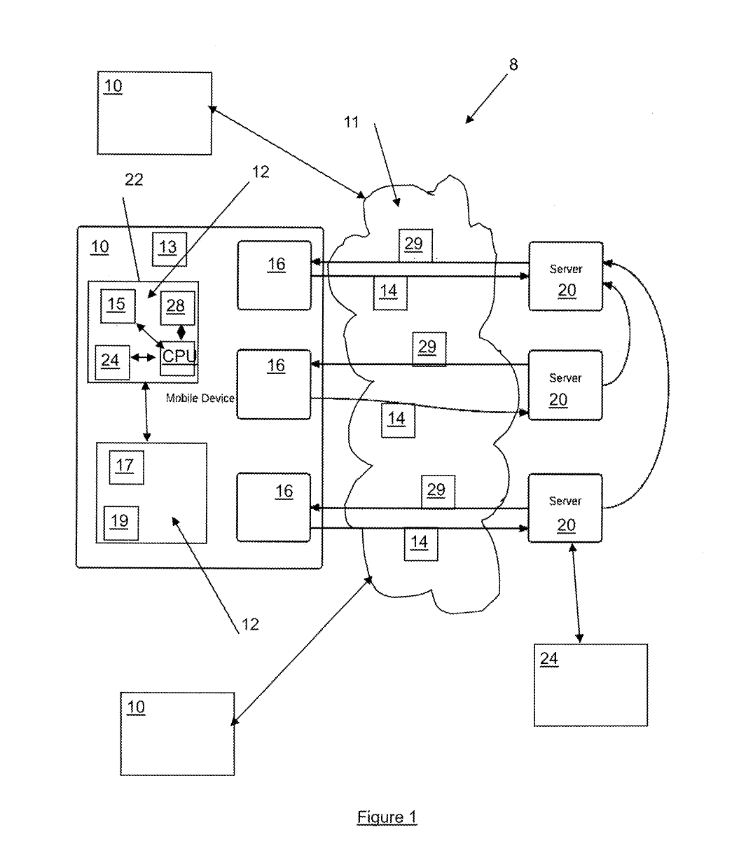

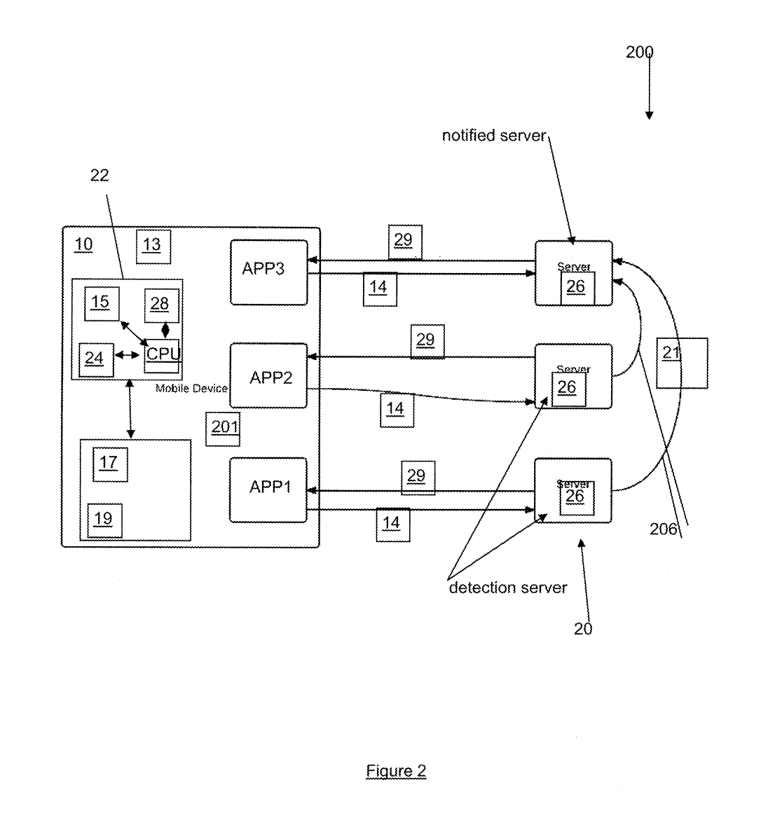

Referring to FIG. 1, shown is an example configuration of a communications environment having a server 20 (e.g. detection server 20—see FIG. 2) and associated servers 20 (e.g. notified servers 20—see FIG. 2). Each of the servers 20 has at least one application 16 running on the device 10 and/or are in communication with the device 10 over the network 11, such that the device 10 can have network access to services and/or data provided by the servers 20. For example, a first server 20 is configured to communicate with the device 10 via a first client application 16 (e.g. a device application that was installed and/or is managed by the first server) and a second server 20 is configured to communicate with the device 10 via a second client application 16 (e.g. a device application that was installed and/or is managed by the second server), such that the first application 16 may not be configured to communicate as a client of the second server 20 and the second application 16 may not be configured to communicate as a client of the first server 20. In other words, the first application 16 is in a client-server relationship with the first server 20 and the second application 16 is in a client-server relationship with the second server 20.

For example, the device 10 can be a computing device 10 employed by a device user (e.g. a personal computing device). Examples of the device 10 can include such as but not limited to: a mobile device; a smart phone, a wireless phone; a PDA; a tablet; and/or a desktop computer. Accordingly, the computing device 10 can be connected to the network 11 via a wireless connection. Accordingly, the computing device 10 can be connected to the network 11 via a wired connection.

For example, any or all of the servers 20 (e.g. detection server, notified server, etc.) can be enterprise servers. As such, the servers 20 can be represented by physical computer devices (e.g. a configured computer hardware system) dedicated to run one or more services (e.g. as a host of the services) to serve the needs of the users of the devices 10 (and application(s) 16 affiliated with the respective server 20) on the network 11. Depending on the computing service (e.g. data processing, data access, etc.) that the server 20 offers, the server 20 could be a database server, file server, mail server, print server, web server, gaming server, or some other kind of server. In the context of client-server architecture, the server 20 can be defined as a computer program running to serve the requests of other programs 16, the “clients”. Thus, the “server” performs some computational task (including data access to data accessible via the server 20—e.g. in server storage 24) on behalf of “clients”. In the present context, the clients (coordinating the device 10 access and communication with the server) run on the device 10 and connect through the network 11 with the server 20 affiliated with the client application 16. It is recognized that the relationship of the client application 16 with it's affiliated server 20 is typically done on a one-to-one basis, such that a client application 16 affiliated with one server 20 is not configured as client of a different server 20 (e.g. the client application 16 affiliated with the detection server 20 may not be a client of the notified server 20). Further, the server 20 can be configured as the detection server 20. Further, the server 20 can be configured as the notified server 20. Further, the server 20 can be configured as both the detection server 20 and the notified server 20.

It is also recognized that a personal computer 10 (e.g. desktop, mobile device, etc.) can be configured as a server 20 or otherwise be configured to act as a server 20 in communication with another device 10 over the network 11. As such, the server 20 capable of acting as a network server for the device 10 may contain features (e.g. hardware, software, network connectivity) making the server 20 more suitable for production environments over the features of the device 10. These features can include a faster CPU, increased high-performance RAM, and increased storage capacity in the form of a larger or multiple hard drives, as compared to such features typically had by personal computer devices 10. Servers 20 can also have reliability, availability and serviceability (RAS) and fault tolerance features, such as redundancy in power supplies, storage (as in RAID), and network connections. However, as discussed, it is recognized that personal computer device 10 can be configured on the network 11 to communicate as a server with an affiliated client application 16 on another personal computer device 10 on the network 11. For example, the personal computer device 10 can be configured as the detection server 20. Further, the personal computer device 10 can be configured as the notified server 20. Further, the personal computer device 10 can be configured as both the detection server 20 and the notified server 20.

Preferably, the communications network 11 comprises a wide area network such as the Internet, however the network 11 may also comprise one or more local area networks 11, one or more wide area networks, or a combination thereof. Further, the network 11 need not be a land-based network, but instead may comprise a wireless network and/or a hybrid of a land-based network and a wireless network for enhanced communications flexibility. The communications network 11 is used to facilitate network interaction between the devices 10 and the servers 20. The communications network 11 is used to facilitate network interaction between the servers 20 with each other. In terms of communications on the network 11, these communications can be between the computer devices (e.g. device 10 and device 20) consisting of addressable network packages following a network communication protocol (e.g. TCPIP), such that the communications can include compliance characteristic data 14 communicated using appropriate predefined encryption as used between the device infrastructure 22 and the secure enterprise mobile services gateway or server (e.g. remote computer device 20). As discussed below, the compliance characteristic data 14 is representative of device installed limitation(s) 12 present on the device 10.

In this manner, the device 10 has a plurality of applications 16 that are configured to communicate with a corresponding plurality of respective servers 20 over the communications network 11, such that at least one of the applications 16 communicates with a respective detection server 20 of the plurality of servers 20 and another of the applications 16 communicates with a different notified server 20 of the plurality of servers 20. It is recognized that due to different applications 16 communicating with different servers 20, there is a potential for one of the servers 20 (e.g. detection server 20) to discover via it's corresponding first application 16 that the device 10 has been compromised or exploited (e.g. jailbroken or rooted) while the second server 20 (e.g. notified server 20) remains unaware of the compromised status (also referred to as exploited status) of the device 10 since communications have not occurred between the second server 20 and the first application 16. Accordingly, upon detection/identification of a compromise or circumvention status of the device 10, one or more of the servers 20 (e.g. detection server 20—see FIG. 2) are configured to generate a notification 206 to be sent to one or more other servers 20 (e.g. notified servers 20) also having application(s) 16 installed/configured on the device 10. For example, detection server 20 can detect/identify the compromise or circumvention (e.g. exploited) status of the device 10 and then generate and send the notification 206 to one or more of the notified servers 20. It is recognized that the notification 206 can be sent directly between the servers 20 over the network 11 (e.g. by detection server 20 addressed to notified server 20). Alternatively, the notification 206 can be sent indirectly between the servers 20 over the network 11 via a third party device 21 (e.g. by detection server 20 addressed to notified server 20 via the proxy service or device 21).

As discussed below, determination of compromise or circumvention (e.g. exploited) of the device 10 is based on the determination or detection of circumvention (e.g. exploited) of device installed limitations 12 present on the device 10, such that the device installed limitations 12 can be associated with an operating system 17 of the device 10. Alternatively or in addition to, the device installed limitations 12 can be associated with firmware 19 of the device 10. Alternatively or in addition to, the device installed limitations 12 can be associated with one or more configured hardware components of a device infrastructure 22 of the device 10. Alternatively or in addition to, the device installed limitations 12 can be associated with one or more configured applications 16 of the device 10. These device installed limitations 12 can be related to security aspects, such as but not limited to data access or communication (e.g. reception and/or transmission), local data storage, server access, and/or device 10 to device 10 communications.

### Example Device Installed Limitations 12

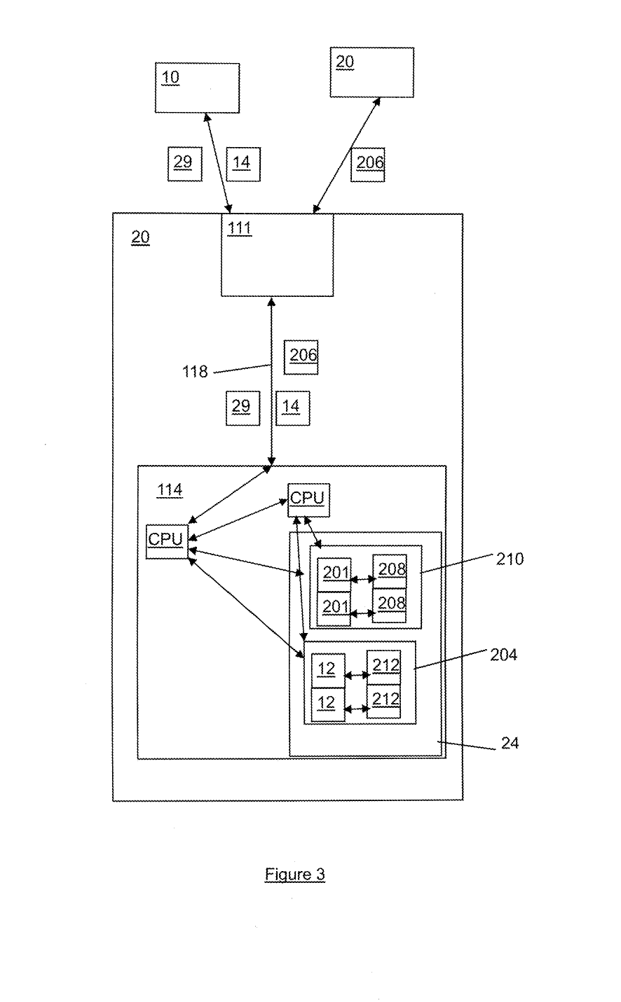

Referring to again to FIG. 1, device installed limitation 12 circumvention (e.g. limitation removal or alteration) is used by device owners and/or software developers to facilitate installation and execution of unauthorized software applications (e.g. apps) 13 on a device 10 (e.g. mobile phones and other network enabled devices) and/or to alter capabilities (e.g. specified country and network connectivity interface 15—e.g. SIM card—of a device hardware infrastructure 22) built into the device 10 by device manufacturers. Network providers (e.g. carriers) use these device installed limitations 12 to restrict the use of the devices 10 to specific countries and network providers. Device installed limitations 12 can be specified by any of the device 10 manufacturer, the carrier providing network service to the device 10, and/or software application providers 20 (e.g. originators and/or administrators of enterprise software installed on the device 10) via the communications network 11. As discussed below, the device installed limitations 12 can be defined in a security policy 204 (see FIG. 3) accessible by the servers 20 (e.g. detection server 20), such that contravention (e.g. circumvention of one or more of the device installed limitations 12) could render the device 10 labeled/determined/identified as compromised/circumvented (e.g. exploited) in view of its contravention of the security policy 204.

Examples of device installed limitations 12 can include limitations such as but not limited to: alternation(s) regarding device operating system 17 configuration or firmware 19 configuration—including the presence, modification or removal of predefined system 17 files, system 17 data, firmware 19 files, firmware 19 data, links between system 17 files, links between a system 17 file and system 17 data, links between a firmware 19 file and firmware 19 data and/or links between firmware 19 files; allowed device application 16 functionality with respect to the device infrastructure 22; permitted applications 16 installable on device 10; modification and/or deletion of specified operating system 17 or firmware 19 files; and/or use of specified commands (e.g. administrator level commands).

As further described below, one or more compliance characteristics 14 are communicated over the network 11 between the device(s) 10 (via applications 13, 16) and an associated server 20, and/or between respective servers 20, such that each of the servers 20 interacts with or otherwise manages respective applications 16 on the device 10. The compliance characteristics 14 can include information about the device installed limitations 12, such as data representing the device installed limitation 12 itself (e.g. operating system version number) and/or data representing that the device installed limitation 12 has been circumvented (e.g. indication of a jailbreak or root detection state of the device 10). The compliance characteristics 14 are used by the servers 20 to determine what remedial action 212, if any, is to be taken based on the data of the compliance characteristics 14.

### Firmware 19

Referring again to FIG. 1, in electronic systems and computing, firmware 19 can be defined as the combination of storage 24 (e.g. persistent) and program code and data stored in it (as provided in a device infrastructure 22). Typical examples of devices 10 containing firmware 19 are embedded systems (such as traffic lights, consumer appliances, and digital watches), computers, computer peripherals, mobile phones, and digital cameras. The firmware 19 contained in the device 10 can provide the control program for the device 10. Firmware 10 can be held in non-volatile memory devices of the storage 24 such as ROM, EPROM, or flash memory of the device hardware infrastructure 22. Common reasons for legitimately updating (i.e. not circumventing device installed limitations 12) firmware 19 can include fixing bugs or adding features to the device 10. Updating of the firmware 19 can be facilitated by physically changing the storage 24 (e.g. ROM integrated circuits), or reprogramming the storage 24 (e.g. flash memory with a predefined update procedure) of the device hardware infrastructure 22. Firmware 19, such as the ROM BIOS of a personal computer, can contain only elementary basic functions of the device 10 and can provide services to higher-level software. Other examples of firmware 19 can include the program of an embedded system that is the fundamental program that will run on the device 10 system (e.g. device hardware 22 and associated lower level software) and provide access to lower level device 10 functionality and hardware of the device infrastructure 22.

The firmware 19 of the device 10 can be defined as the contents of a writable control store (a small specialized high speed memory 24 of the device infrastructure 22) containing microcode that defines and implements a central processing unit's (CPU) instruction set, and that can be reloaded to specialize or modify the instructions that the central processing unit (CPU) could execute. It is recognized that firmware 19 can be contrasted with hardware (the CPU itself) and software (normal instructions executing on a CPU), and as such the firmware 19 may not be composed of CPU machine instructions, but of lower-level microcode involved in the implementation of machine instructions by the CPU. Firmware can also be defined to denote anything ROM-resident (e.g. flash memory), including processor machine-instructions for BIOS, bootstrap loaders, or specialized applications of the device 10. In terms of updating the contents of firmware 19, it is recognized that updating firmware 19 can involve replacing a storage medium containing firmware (e.g. a socketed ROM memory) and/or using a writeable memory such as flash memory to provide for the firmware 19 to be updated without physically removing an integrated circuit from the device infrastructure 22.

Based on the above, it is recognized that configuration of the firmware 19 can include device installed limitations 12. Any circumvention (e.g. exploited) of the device installed limitations 12 of the firmware 19 would be represented in compliance characteristic 14 data communicated from the device 10 (e.g. via any applications 13,16 whose interaction with the server 20 utilizes or otherwise has knowledge of the circumvented (e.g. exploited) device installed limitations 12) to the server(s) 20 associated with the application(s) 15,16. For example, the applications 13,16 can be configured as stand-alone applications that provide data to the server(s) 20 over the communications network 11. For example, the applications 13,16 can be configured as a client application in a client-server relationship with the server 20, such that the applications 13,16 access application functionality from the server 20 over the communications network 11.

The compliance characteristic 14 data can include information about the device installed limitations 12 associated with the firmware 19, such as data representing the device installed limitation 12 itself (e.g. firmware version number) and/or data representing that the device installed limitation 12 has been circumvented/exploited (e.g. indication of a jailbreak or root detection state of the firmware 19 via detected modification of one or more of the device installed limitation 12). One example of a detected modification would be the substitution of one system 17 file for a different system 17 file. A further example of a detected modification would be the deletion of a system 17 file. A further example of a detected modification would be the substitution of one system 17 data for a different system 17 data. A further example of a detected modification would be the deletion of a system 17 data. One example of a detected modification would be the substitution of one firmware 19 file for a different firmware 19 file. A further example of a detected modification would be the deletion of a firmware 19 file. A further example of a detected modification would be the substitution of one firmware 19 data for a different firmware 19 data. A further example of a detected modification would be the deletion of a firmware 19 data.

The compliance characteristics 14 are used by the servers 20 to determine what remedial action 212, if any, is to be taken based on the data of the compliance characteristics 14 as compared to the security policy 204 of the respective server 20.

### Operating System 17

The operating system (OS) 17 can be defined as a collection of software that manages computer hardware resources of the device infrastructure 22 and provides a common services platform for computer applications 13,16 (e.g. stand-alone applications, client applications of server applications 26, etc.) installed on the device 10. Application programs 16 use the operating system 17 to provide their application specific functionality (e.g. application data processing via the CPU, data persistence in the storage 24, communication/interaction of data via the network interface 15, and/or interaction with the device user via a user interface 28 (e.g. touch screen). The operating system can also be configured to implement scheduling of tasks for efficient use of the device infrastructure 22 and can also include accounting for cost allocation of processor time, mass storage, printing/display, and other resources.

As such, the user software applications 13,16 are configured to use the operating system 17 in order to access any of the hardware of the device infrastructure 22, whether it be as simple as a mouse or keyboard or as complex as interaction with server functionality over the network 11. The operating system provides an interface between the application program(s) 13,16 and the computer hardware of the device infrastructure 22, so that the application program 13,16 can interact with the hardware only by obeying rules and procedures programmed into the operating system 17. The operating system 17 can be defined as a set of services which simplify development and execution of application programs 13,16. As discussed below, executing the application program 13,16 (e.g. accessing the application 13,16 functionality by the device 10 with or independently from the device user) involves the creation of a process by the operating system 17 kernel, which can assign memory 24 space and other resources, establish a priority for the process in multi-tasking systems, load program binary code into memory 24, and/or initiate execution of the application program 13,16 which then interacts with the user and with other hardware devices of the device infrastructure 22.

For hardware functions such as input and output and memory allocation, the operating system 17 acts as an intermediary between programs 16 and the computer hardware (e.g. the device infrastructure 22), although the application code of the programs 13,16 is usually executed directly by the hardware (e.g. CPU) and the application code can make a system call to an operating system 17 function or be interrupted by an operating system 17 function. Interrupts via the operating system 17 can provide an efficient way for the operating system 17 to interact with and react to its environment. A program 13,16 may trigger an interrupt to the operating system 17, for example if the program 13,16 wishes to access hardware the program 13,16 may interrupt the operating system's 17 kernel, which causes control to be passed back to the kernel. The kernel will then process the request. If the program 13,16 wishes additional resources (or wishes to shed resources) such as memory 24, the program 16 will trigger an interrupt to get the kernel's attention.

The kernel of the operating system 17 connects the application 13,16 software to the hardware (e.g. device infrastructure 22) of the device 10. With the aid of the firmware 19 and device drivers stored in them storage 24, the kernel can provide the most basic level of control over all of the hardware devices of the device infrastructure 22. The operating system 17 (via the kernel) can manage memory 24 access for programs 13,16 in the RAM, can determine which programs 13,16 get access to which hardware resources, can set up or resets the CPU's operating states for optimal operation, and can organize the data for long-term non-volatile storage with file systems in the storage 24 media. The operating system 17 can also support multiple modes of operation, e.g. protected mode and supervisor mode. The supervisor mode is used by the operating system's 17 kernel for low level tasks that need unrestricted access to hardware, such as controlling how memory is written and erased, and communication with devices like graphics cards. Protected mode, in contrast, can be used by the applications 13,16 to facilitate access to desired hardware by communicating with the kernel, which controls such access via the supervisor mode.

Examples of the operating system 17 can include a real-time operating system that is a multitasking operating system that aims at executing real-time applications 13,16. Real-time operating systems 17 can use specialized scheduling algorithms so that they can achieve a deterministic nature of behavior. An objective of real-time operating systems 17 is their timely and predictable response to application 13,16 events. Another objective of real-time operating systems 17 is their timely and predictable response to user events of the user via the user interface 28. Operating systems 17 can have an event-driven or time-sharing design and often aspects of both. An event-driven system switches between tasks based on their priorities or external events while time-sharing operating systems switch tasks based on clock interrupts. Another example of the operating system 17 is an embedded operating systems designed to be used in embedded computer systems, such as smaller machines such as PDA versions of the devices 10 with less autonomy. Embedded operating system 17 can be configured to operate with a limited number of resources, can have a compact memory footprint, and can be highly optimized for the device infrastructure 22. Windows CE and Minix 3 are some examples of embedded operating systems.

Based on the above, it is recognized that configuration of the operating system 17 can include one or more device installed limitations 12. Any circumvention of the device installed limitations 12 associated with the operating system 17 would be represented in compliance characteristic 14 data communicated from the device 10 (e.g. via any applications 13,16 whose interaction with the server 20 utilizes or otherwise has knowledge of the circumvented device installed limitations 12) to the server(s) 20 associated with the application(s) 13,16. For example, the applications 13,16 can be configured as stand-alone applications that provide data to the server(s) 20 over the communications network 11. For example, the applications 13,16 can be configured as a client application in a client-server relationship with the server 20, such that the applications 13,16 access application functionality from the server 20 over the communications network 11. The compliance characteristic 14 data can include information about the device installed limitations 12 of the operating system 17, such as data representing the device installed limitation 12 itself (e.g. operating system version number) and/or data representing that the device installed limitation 12 has been circumvented (e.g. indication of a jailbreak or root detection state of the operating system 17). The compliance characteristics 14 are used by the servers 20 to determine what remedial action, if any, is to be taken based on the data of the compliance characteristics 14.

### Device Infrastructure 22

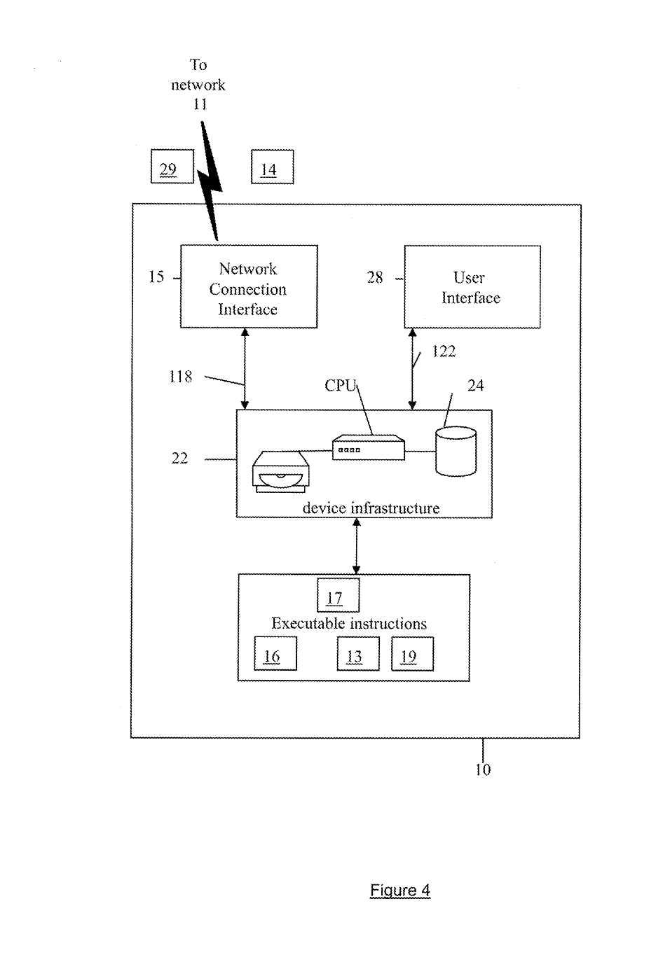

Referring to FIG. 4, shown is an example device infrastructure 22 including the network connection interface 15, such as a network interface card (e.g. SIM) or a modem, coupled via connection 118 to the device infrastructure 22. The network connection interface 15 is connectable during operation of the devices 10 to the network 11 (e.g. an intranet and/or an extranet such as the Internet), which enables the devices 10 to communicate with each other as appropriate. The network 11 can support the communication of the compliance characteristic communications 14, server command message 29, and the related content.

Referring again to FIG. 4, the device 10 can also have a user interface 28, coupled to the device infrastructure 22 by connection 122, to interact with a user (not shown). The user interface 28 can include one or more user input devices such as but not limited to a QWERTY keyboard, a keypad, a stylus, a mouse, a microphone and the user output device such as an LCD screen display and/or a speaker. If the screen is touch sensitive, then the display can also be used as the user input device as controlled by the device infrastructure 22.

Referring again to FIG. 4, operation of the device 10 is facilitated by the device infrastructure 22. The device infrastructure 22 includes one or more computer processors CPU and can include an associated memory 24. The computer processor CPU facilitates performance of the device 10 configured for the intended task (e.g. of the respective module(s) of applications 13,16) through operation of the network interface 15, the user interface 28 and other application programs/hardware of the device 10 by executing task related instructions. These task related instructions can be provided by the operating system 17, and/or software applications 13,16 located in the memory 24, and/or by operability that is configured into the electronic/digital circuitry of the processor(s) CPU designed to perform the specific task(s). Further, it is recognized that the device infrastructure 22 can include a computer readable storage medium 24 coupled to the processor CPU for providing instructions to the processor CPU and/or to load/update the instructions. The computer readable medium 24 can include hardware and/or software such as, by way of example only, flash memory, optically readable medium such as CD/DVD ROMS, and memory cards. In each case, the computer readable medium 24 may take the form of a small disk, hard disk drive, solid-state memory card, or RAM provided in the memory module 24. It should be noted that the above listed example computer readable mediums can be used either alone or in combination.

Further, it is recognized that the computing device 10 can include the executable applications 13,16 comprising code or machine readable instructions for implementing predetermined functions/operations including those of an operating system and the modules, for example. The processor CPU as used herein is a configured device and/or set of machine-readable instructions for performing operations as described by example above, including those operations as performed by any or all of the applications 13,16, firmware 19 and/or operating system 17. As used herein, the processor CPU may comprise any one or combination of, hardware, firmware, and/or software. The processor CPU acts upon information by manipulating, analyzing, modifying, converting or transmitting information for use by an executable procedure or an information device, and/or by routing the information with respect to an output device. The processor CPU may use or comprise the capabilities of a controller or microprocessor, for example. Accordingly, any of the functionality of the modules may be implemented in hardware, software or a combination of both. Accordingly, the use of a processor CPU as a device and/or as a set of machine-readable instructions is referred to generically as a processor/module for sake of simplicity.

Based on the above, it is recognized that configuration of the device infrastructure 22 can include device installed limitations 12. Any circumvention of the device installed limitations 12 associated with the device infrastructure 22 would be represented in compliance characteristic 14 data communicated from the device 10 (e.g. via any applications 13,16 whose interaction with the server 20 utilizes or otherwise has knowledge of the circumvented device installed limitations 12) to the server(s) 20 associated with the application(s) 13,16. For example, the applications 13,16 can be configured as stand-alone applications that provide data to the server(s) 20 over the communications network 11. For example, the applications 13,16 can be configured as a client application in a client-server relationship with the server 20, such that the applications 13,16 access application functionality from the server 20 over the communications network 11. The compliance characteristic 14 data can include information about the device installed limitations 12 of the device infrastructure 22, such as data representing the device installed limitation 12 itself (e.g. version number of one or more components of the device infrastructure 22, version number of one or more component drivers of the device infrastructure 22) and/or data representing that the device installed limitation 12 has been circumvented (e.g. indication of a jailbreak or root detection state of the one or more components of the device infrastructure 22). The compliance characteristics 14 are used by the servers 20 to determine what remedial action, if any, is to be taken based on the data of the compliance characteristics 14.

### Examples

### Device Installed Limitation 12 and Compliance Characteristic 14

Referring again to FIG. 1, as further described below, compliance characteristics 14 obtained from one or more applications 13,16 on the device 10 can be associated with circumvention (e.g. removal or redirection) of the device installed limitations 12, as one or more of the application(s) 16 (e.g. authorized) can be configured to recognize and report suspected circumvention (e.g. exploited) of one or more device installed limitations 12 and/or to periodically report compliance characteristics 14 even if circumvention is not detected/suspected at reporting time by the application(s) 13,16. As such, as further described below, one or more of the servers 20 receives the compliance characteristics 14 via network 11 communications with the device 10. In response, the server 20 can compare the compliance characteristic(s) 14 with the security policy 204 (see FIG. 2) and provide a server command message 29 to the device 10 and/or send a device status message 206 (e.g. notification 206) to another server 20 also associated with the device 10.

It is recognized that the status message 206 can be sent as a notification, either as a synchronous message or an asynchronous message with respect to the message sending and message receiving servers 20. For example, synchronous message passing systems provide for the sender and receiver to wait for each other to transfer the message. That is, the sender can not continue until the receiver has received the message. Asynchronous message passing systems can deliver a message from sender to receiver, without waiting for the receiver to be ready. The advantage of asynchronous communication is that the sender and receiver can overlap their computation because they do not wait for each other. It is also recognized that the sending of the status message 206 by the detection server 20 can be in response to receipt of a status poll message (e.g. from the notified server 20) requesting the status of one or more particular devices 10 that are managed by the detection server 20 (e.g. those devices 10 with which the detection server 20 has a client-server relationship).

For example, removal/modification of the device installed limitations 12 can enable user-installed applications to run privileged commands that are typically unavailable to the devices 10 in their stock configuration. Other consequences of removing/modifying device installed limitations 12 include operations associated with modifying or deleting system files, removing carrier- or manufacturer-installed applications, and/or low-level access to the hardware itself (e.g. rebooting, controlling status lights, or recalibrating touch inputs.) Typical removal of the device installed limitations 12 can also include installation of an unauthorized “Superuser application” 13 (e.g. supervisor application) on the device 10, such that the Superuser application 13 once on the device 10 supervises other applications 13,16 that are granted root or superuser rights that are enabled by the circumvention of the device installed limitations 12.

As such, it is recognized that a consequence of removal/modification of one or more device installed limitations 12 can result in an unauthorized application 13 being installed on the device 10, such that the unauthorized application 13 brokers communications between one or more of the hardware components (e.g. with their respective device driver) of the device infrastructure 22 and the authorized applications 16. As such, it is recognized that a consequence of removal/modification of one or more device installed limitations 12 can result in an unauthorized application 13 being installed on the device 10, such that the unauthorized application 13 brokers communications between the operating system 17 of the device 10 and the authorized applications 16. As such, it is recognized that a consequence of removal/modification of one or more device installed limitations 12 can result in an unauthorized application 13 being installed on the device 10, such that the unauthorized application 13 brokers communications between the firmware 19 of the device 10 and the authorized applications 16. Accordingly, the compliance characteristic 14 data relating to the unauthorized application 13 can include detection data by another application 16 (e.g. detection application 16) of the presence of the unauthorized application 13 on the device 10, and/or can include unauthorized application 13 data exhibited by the unauthorized application 13 during interaction of the unauthorized application 13 with the operating system 17, firmware 19, server 20, and/or a component of the device infrastructure 22). For example, the presence of unauthorized application 13 data can be detected by the server 20 in compliance characteristic(s) 14 (e.g. application version number, authorship of application, and/or security policy data) contained in the communications between the server 20 and the unauthorized application 13 over the network 11.

Alternatively, it is recognized that an authorized application 16 can be modified or reconfigured (e.g. one or more of the device installed limitations 12 relating to the authorized application 16 is removed or circumvented), such that the modified/reconfigured version of the authorized application 16 is configured to interact with any of the hardware components (e.g. with their respective device driver) of the device infrastructure 22 in an unauthorized fashion. Alternatively, the modified/reconfigured version of the authorized application 16 is configured to interact with the operating system 17 in an unauthorized fashion. Alternatively, the modified/reconfigured version of the authorized application 16 is configured to interact with the firmware 19 in an unauthorized fashion. Examples of this reconfiguration can include allowing interaction between the modified/reconfigured version of the authorized application 16 and a different application 13,16 normally restricted by a device installed limitation 12 relating to the authorized application 16. A further example of this reconfiguration can include allowing interaction between the modified/reconfigured version of the authorized application 16 and different hardware component of the device infrastructure 22 that is normally restricted by a device installed limitation 12 relating to the authorized application 16. A further example of this reconfiguration can include allowing interaction between the modified/reconfigured version of the authorized application 16 and a different command of the operating system 17 that is normally restricted by a device installed limitation 12 relating to the authorized application 16. A further example of this reconfiguration can include allowing interaction between the modified/reconfigured version of the authorized application 16 and a different system file of the operating system 17 that is normally restricted by a device installed limitation 12 relating to the authorized application 16. Accordingly, the compliance characteristic 14 data relating to the modified/reconfigured version of the authorized application 16 can include detection data by another application 16 (e.g. detection application 16) of the presence of the modified/reconfigured version of the authorized application 16 on the device 10, and/or can include modified/reconfigured version of the authorized application 16 data exhibited by the modified/reconfigured version of the authorized application 16 during interaction of the modified/reconfigured version of the authorized application 16 with the operating system 17, firmware 19, server 20, and/or a component of the device infrastructure 22). For example, the presence of modified/reconfigured version of the authorized application 16 data can be detected by the server 20 in compliance characteristic(s) 14 (e.g. application version number, authorship of application, and/or security policy data) contained in the communications between the server 20 and the modified/reconfigured version of the authorized application 16 over the network 11.

In general, circumvention of the device installed limitations 12 can involve circumventing (e.g. exploited) the device's 10 technological protection measures (in order to allow root access and running alternative software), so the device's 10 legal status is affected by laws regarding circumvention of digital locks, such as laws protecting digital rights management (DRM) mechanisms. The device installed limitations 12 are configured to prohibit tampering with the digital locks, which can restrict installation and execution of alternative software applications 13 for the purpose of affecting software interoperability (e.g. between applications 13 and 16 and/or between applications 16 and 16). As such, circumvention of device installed limitations 12 is often performed with the goal of overcoming limitations that carriers and hardware manufacturers put on the platform (e.g. hardware 22 and/or software 17,19) of the device 10, resulting in the ability to alter or replace system applications and settings, run specialized apps that require administrator-level permissions, or perform other operations that are otherwise inaccessible to a normal device 10 user.

Specific examples of device installed limitations 12 circumvention (e.g. exploited) are “Rooting” and “Jailbreaking” (e.g. exploited). The process of rooting varies widely by device 10, but can include exploiting a security weakness in the operating system 17 and/or firmware 19 of the device 10. Rooting (e.g. exploited) of an Android™ device 10 is similar to jailbreaking (e.g. exploited) devices 10 running the Apple™ iOS operating system 17. On Android, rooting can also facilitate the complete removal and replacement of the device's 10 operating system 17, usually with a more recent release of its current operating system 17. iOS jailbreaking can be defined as the process of removing the limitations imposed by Apple on devices 10 running the iOS operating system through the use of software exploits—such devices 10 can include the iPhone, iPod touch, iPad, and second generation Apple TV. Jailbreaking allows iOS users to gain root access to the operating system 17, allowing them to download additional applications, extensions, and/or themes that are unavailable through the official Apple App Store (e.g. server 20). Jailbreaking can also be referred to as a form of privilege escalation. As discussed above, a jailbroken device 10 running the original operating system 17 can still use the App Store, iTunes and other server 20 related access, and other normal functions, such as making telephone calls via the network interface 15.

It is also recognized that in contrast to iOS jailbreaking, rooting may not be needed to run applications 13,16 distributed outside of the sanctioned server 20 supplying the applications 13,16, sometimes referred to as “sideloading”. The Android operating system 17 can support this feature natively in two ways. However some carriers can prevent the installation of applications 13,16 not found on the sanctioned server 20 in the firmware 19.

### Example Compliance Characteristics 14

Referring again to FIG. 1, an example compliance characteristic 14 can be a version number of the device operating system 17 of the device 10. Alternatively, the compliance characteristic 14 can be a version number of the firmware 19 of the device 10. Alternatively, the compliance characteristic 14 can be a confirmation from one of the applications 16 of a jailbreak detection (e.g. exploited) for the device 10. Alternatively, the compliance characteristic 14 can be a confirmation from one of the applications 16 of a root detection for the device 10. Alternatively, the compliance characteristic 14 can be a directory path in a file system of the device 10. Alternatively, the compliance characteristic 14 can be a unauthorized directory path in a file system of the device 10. Alternatively, the compliance characteristic 14 can be a directory permission for a predefined directory in a file system of the device 10. Alternatively, the compliance characteristic 14 can be an unauthorized directory permission for a predefined directory in a file system of the device 10. Alternatively, the compliance characteristic 14 can be a file permission for a predefined file in a file system of the device 10. Alternatively, the compliance characteristic 14 can be an unauthorized file permission for a predefined file in a file system of the device 10. For example, the (unauthorized) file permission can be a write permission. Alternatively, the compliance characteristic 14 can be existence of process forking. Alternatively, the compliance characteristic 14 can be existence of unauthorized process forking. Alternatively, the compliance characteristic 14 can be an indication of a connection to predefined network server address on predefined server port. Alternatively, the compliance characteristic 14 can be an indication of an unauthorized connection to predefined network server address on predefined server port. Alternatively, the compliance characteristic 14 can indicates existence of return data for a predefined function call by an application 13,16. Alternatively, the compliance characteristic 14 can indicates existence of improper return data for a predefined function call by an application 13,16.

As such, in view of the above the compliance characteristic 14 can be a reporting of the actual device installed limitation 12 (e.g. version number of the device operating system 17). The compliance characteristic 14 can also be a judgment on the device installed limitation 12 (e.g. unauthorized version number of the device operating system 17).

### Other Examples of Circumvented Device Installed Limitations 12

Referring to FIG. 1, computer device 10 operating states based on modification/alternation of device installed limitations 12 can be as follows. When the device 10 is booting, it loads the server's 20 own kernel initially, e.g. the original kernel of the authorized operating system 17 (i.e. that operating system 17 that does not have any of its device installed limitations 12 circumvented). The device 10 must then be exploited and have the kernel of the authorized operating system 17 patched (e.g. circumvented) each time it is turned on, thus resulting in the modified operating system 17 now considered as being circumvented (e.g. one or more system files are either removed or modified).

In one example operating state, an untethered circumvention (e.g. jailbreak, root, etc.) has the property that if the user turns the device 10 off and back on, the device 10 will start up completely, and the kernel of the authorized operating system 17 will be patched (e.g. circumvented) without the help of a computer—in other words, the operating system 17 will be circumvented after each reboot, thus resulting in a modified operating system 17 now considered as being circumvented (e.g. one or more system files are either removed or modified).

With a tethered circumvention (e.g. jailbreak, root, etc.), if the device 10 starts back up on its own, the device 10 will no longer have a patched (e.g. circumvented) kernel, and it may get stuck in a partially started state; in order for the device 10 to start completely and with the patched kernel, the device 10 must be “re-jailbroken” with a computer (using the “boot tethered” feature of a circumvention tool such as an unauthorized application 13) each time the device 10 is turned on, thus resulting in a modified operating system 17 now considered as being circumvented (e.g. one or more system files are either removed or modified).

In another example operating state, a device 10 with a tethered circumvention (e.g. jailbreak, root, etc.) may have a semi-tethered solution, which means that when the device 10 boots, the device 10 will no longer have a patched (e.g. circumvented) kernel (so the device 10 will not be able to run modified code), but the device 10 will still be usable for normal functions. To use any features that require running modified code, the user starts the device 10 with the help of the tool in order for it to start with a patched (e.g. circumvented) kernel, thus resulting in the modified operating system 17 now considered as being circumvented (e.g. one or more system files are either removed or modified).

In further example operating states, the process of rooting (e.g. circumvention) varies widely by device 10, but can includes exploiting a security weakness in the firmware 19 (or operating system 17) of the device 10, and then copying an su binary to a location in the current process's PATH (e.g. /system/xbin/su) and granting it executable permissions with a chmod command. A supervisor application 13 like SuperUser or SuperSU can regulate and log elevated permission requests from other applications 16. Many guides, tutorials, and automatic processes exist for popular Android devices facilitating a fast and easy rooting process. For example, shortly after the T-Mobile G1 was released it was quickly discovered that anything typed using the keyboard was being interpreted as a command in a privileged (root) shell. Although a system upgrade was released by the server 20 to fix security weakness, a signed image of the old firmware 19 leaked, which gave users of the device 10 the ability to downgrade and use the original exploit to gain root access. Once an exploit is discovered, a custom recovery image that skips the digital signature check of the firmware 19 update package can be flashed. In turn, using the custom recovery, a modified firmware 19 update can be installed that typically includes the utilities (for example the Superuser app 13) needed to run apps 13,16 as root.

Other example operating states include devices 10 that can be boot-loader unlocked by simply connecting the device 10 to a computer while in boot-loader mode and running a Fastboot program with an exploit command (e.g. command “fastboot oem unlock”). After accepting a warning the boot-loader can be unlocked so that a new system image can be written directly to flash 24 without the need for an exploit.

As such, the compliance characteristic 14 can be associated with or otherwise represent the computer device 10 operating states. In other words, the device 10 operating states can be reported by data contained in the compliance characteristic 14 communicated to the server 20.

### Server 20 Example Configurations

Referring again to FIG. 2, shown is an example configuration of the server 20 (e.g. detection server 20) and associated servers 20 (e.g. notified servers 20 that each have at least one application 16 running on the device 10 and/or are in communication with the device 10 over the network 11, such that the device 10 can have network access to services and/or data provided by the server 20). In this manner, the device 10 has a plurality of applications 16 that configured to communicate with a corresponding plurality of servers over the network 11, such that at least two of the applications 16 each communicate with a respective different server 20 of the plurality of servers 20.

In the client-server configuration between the device 10 (via one or more applications 13,16) and the servers 20, a circumvented operating system 17 can employ techniques that inhibits accurate and timely detection of the device 10 platform being jailbroken/rooted (i.e. circumvented). As such, any of the servers 20 may be in communication (e.g. data/network access) with the device 10 using the client-server application 16 that is not circumvented, however access to any network messaging and/or data content between the server 20 and the respective authorized application 16 can be accessed on the device 10 by other applications 13 and/or the circumvented operating system 17 and/or firmware 19. For example, password information exchanged between the server 20 and the respective authorized application 16 can be intercepted by the circumvented operating system 17 and/or firmware 19 when the authorized application 16 is interacting with one or more components of the device infrastructure 22 (e.g. memory 24 access for password data and/or security encryption data).

In view of the above example, the server 20 would not be aware that enterprise sensitive data is being exposed in an unsecure fashion with other applications 13,16 and/or systems 17,19 of the device 10, even though the interaction between the server 20 and the respective authorized application 16 appears normal to the server 20. Accordingly, although jailbreaking/rooting (i.e. limitation circumvention) has been deemed acceptable from a legal standpoint in various countries, these circumvented devices 10 have had a device installed security model removed. Therefore enterprises 20 do not want jailbroken/rooted devices 10 to access and store enterprise data that can be obtained or otherwise intercepted by one or more other circumvented applications/systems on the device 10. Accordingly, it is preferred that the servers 20 have notifications 206 from other servers 20 (e.g. directly or via a third party service 21) of potential circumvented devices 10, even when the notified server 20 does not have any preexisting evidence of device 10 circumvention.

It is also recognized that checking for device 10 circumvention identification is can be performed by device applications 16 as a circumvention (e.g. jailbreak or root) detection by the client application 16, and are as such can be limited in the circumvention functions in which they are allowed to perform due to other unauthorized applications 13 (or modified systems 17,19) that can block one or more functions of the circumvention (e.g. jailbreak or root) detection. The typical functions that applications 16 would use to detect a jailbroken or rooted device may not be permitted by the circumvented device 10, that if allowed the logic would state that the device 10 has been jailbroken or rooted. Further, applications 13 that have been created in unauthorized App stores (i.e. Cydia) have the capability to re-write commands for detection applications 16 that are inspecting for jailbreaking or rooting, so that any circumvention response by the detection applications 16 will always be that the device 10 has not been jailbroken or rooted. Further, authorized applications 16 on mobile devices 10 are not always permitted to share data with other applications 13,16 on the mobile device 10. However, authorized applications 13,16 are permitted to communicate with a system that is not on the device 10, such as an unauthorized server 20 that did not originate the authorized applications 16. Since unauthorized applications 13 (e.g. obtained from unauthorized apps stores) can mask jailbreak/root detection (e.g. xCon—apps 13 like xCon are written for specific apps 16 so that they can manipulate the response of the jailbreak/root detection determination), shown in FIG. 2 is a server 20 chaining framework 200, such that each of the servers 20 interacts with one or more respective applications 16 on a multi-application 16 device 10. For example, each of the applications 16 can be configured to inspect for jailbreak/root (e.g. removal/modification of device installed limitation(s) 12) on the device 10. When one of the servers 20 detects (e.g. the detection server 20) evidence of removal/modification (e.g. exploited) of device installed limitation(s) 12, via processing of the communicated compliance characteristic(s) 14, the detection server 20 notifies (e.g. via notifications 206) one or more other servers 20 (e.g. the notified server(s) 20) that the device 10 is circumvented (e.g. exploited) in some manner.

In view of the above, it is recognized that a first server 20 can be unaware of the circumvention state of the device 10 it is communicating with over the network 11. As such, it is desirable that the first server 20 receive a circumvention notification 206 from another second server 20, such that the circumvention notification 206 informs the first server 20 of the circumvention (e.g. exploited) state of the device 10. In this manner, the first server 20 can act accordingly for any future interaction with the device 10, once the circumvention notification 206 has been received from the second server 20.

Referring to FIG. 3, server 20 has a network communication interface 111, such as a network interface card or a modem, coupled via connection 118 to a device infrastructure 114. The connection interface 111 is connectable during operation of the server 20 to the network 11 (e.g. an intranet and/or an extranet such as the Internet), which enables the servers 20 to communicate with each other as appropriate, as well as with their respective application(s) 16 installed on the common device 10. The network 11 can support the communication of the communications 14, 29, 206, as further described below, and the related content. The server 20 (e.g. enterprise) is configured for managing server access by a first client application APP1 (see FIG. 2) of the device 10 (e.g. mobile device) over the communications network 11. The server 20 has a set of stored instructions 107 for execution by a computer processor CPU of the device infrastructure 114 to receive a message (e.g. operating system status) via the interface 111 from the first client application APP1 over the communications network 11, the first client application APP1 managed by the server 20, the message including at least one compliance characteristic 14 associated with a security policy 204 of the server 20 and an unique identification 201 of the device 10. As such, the other servers 20 are each coupled to their respective device application APP2 or APP3.

As such, the identification 201 of the device 10 is used to identify the user and/or device account with the server 20 as well as with the other servers 20. In this manner, the first server 20 (e.g. detection server 20) can identify the device 10 by the identification 201 with respect to the security policy 204 (e.g. the identification 201 can be associated with one or more portions of the security policy 204 that are relevant for the device 10 and/or application(s) 16 on the device 10 that are affiliated with the server 20). The identification 201 can also be used to identify what other servers 20 (e.g. notified servers 20) are associated with the device 10 (e.g. those notified servers 20 having one or more application(s) 16 installed on the device 10). The network address 208 (see FIG. 3) of the notified servers 20 can be contained in a file 210 and associated or otherwise cross referenced with the identification 201 of the device 10. the identification 201 can be defined using an alpha based code, a numeric based code, or an alpha-numeric based code to uniquely identify the device 10 in the file 210, such that the network address 208 of affected notified server(s) 20 can be retrieved by the detection server 20 and used to send the notification message 206.

The security policy 204 can be defined as one or more definitions of what it means to be secure for the application 16 (e.g. application APP1) in terms of device 10 configuration, application 16 configuration, network 11 communication configuration, etc. For an organization such as the enterprise, The security policy 204 addresses the constraints (e.g. device installed limitations 12) on behavior of its members (e.g. devices 10 and associated applications 16) as well as constraints (e.g. device installed limitations 12) imposed on adversaries by security mechanisms (e.g. communication restrictions, data access restrictions, etc.). For systems, the security policy 204 addresses constraints (e.g. device installed limitations 12) on functions between the devices 10,20 and flow of information between them, constraints (e.g. device installed limitations 12) on access by external systems and adversaries including programs and access to data by people. If it is important to be secure, then security policy 204 is enforced by mechanisms that are strong enough via use of the device installed limitations 12 and comparison of the received data in the compliance characteristic message 14 based on the device installed limitations 12. There are organized methodologies and risk assessment strategies to provide for completeness of security policies 204 and provide that they are completely enforced. In complex systems, such as information systems, policies 204 can be decomposed into sub-policies to facilitate the allocation of security mechanisms to enforce sub-policies. Example policies of the security policy 204 can include policies such as but not limited to: access control of the server 20; computer security policy of the device 10; information protection policy of data in the storage 24 of the device 10 and/or the server 20; information security policy of data in the storage 24 of the device 10 and/or the server 20; network security policy for network 11 communications between the device 10 and the server 20 and/or between devices 10, and/or between the device 10 and servers 20 other than the server 20 from which server data/services has been obtained by the device 10; and/or user account policy detailing user account privileges of the device user (or device 10) with the server 20. In terms of information security, this can mean protecting information and information systems of the server 20 from unauthorized access, use, disclosure, disruption, modification, perusal, inspection, recording or destruction by the device 10 or other devices in contact with the device 10 over the network 11. As such, the various policies of the security policy 204 include the desired device installed limitations 12 associated therewith, as well as any remedial actions 212 that can be used by the server 20 once circumvention (e.g. exploited) of any of the device installed limitations 12 is detected or otherwise identified.

Further, the security policy 204 can define risk management and the process of identifying vulnerabilities and threats (e.g. desired device installed limitations 12) to the information resources used by an enterprise (e.g. server 20) in achieving business objectives, and deciding what countermeasures 212, if any, to take in reducing risk to an acceptable level, based on the value of the information resource to the organization. The countermeasures 212 can include command messages 29 sent to the device 10, depending upon the corresponding policy associated with the compliance characteristic 14 received from the device 10.

Referring again to FIG. 2, shown is a comparison processor CPU configured to access the security policy 204 and compare the at least one compliance characteristic 14 with a corresponding policy of the security policy 204 to determine (e.g. compare device installed limitation 12 data of the compliance characteristic 14 with compliance with corresponding device installed limitation 12 of the policy 204) a current state (e.g. of an operating system 17) of the device 10 as contrary to the corresponding policy 204 and in response generate a compromised status indicator for the device 10. The server 20 can also access a storage 24 to obtain a network address 208 associated with a second (e.g. enterprise) server 20 managing a second client application APP2 of the device 10 and send the device status message 206 to the network address 208 of the second server 20 including the compromised (e.g. exploited) status indicator and identification data 201 uniquely identifying the device 10 to the second server 20.

Further, the server 20 can be configured with the processor CPU (or other processor CPU) to generate a remedial action 212 based on the policy 204. For example, the remedial action 212 could be to update in the storage 24 a server access status of the device 10 with the server 20 in order to inhibit further server 20 access by the device 10 with the server 10 until receipt of a restore status message indicating the at least one compliance characteristic 14 is again in compliance with the corresponding policy 204. Also, the processor CPU could be further configured to, in combination with updating the server access status, send an alert message to a system administrator (not shown). Further, the processor CPU could be configured to in combination with updating the server access status, send a server command message 29 to the device 10 to affect operation of the device 10. The server command message 29 could include a command selected from the group consisting of: locking overall operation of the device 10; locking operation of the first client application APP1; locking operation of another client application 16 of the device 10 also managed by the server 20; deleting all operational memory 24 of the device 10; deleting the first client application APP1 from operational memory 24 of the device 10; deleting the first client application APP1 and any other one or more client applications 16 also managed by the server 20 from operational memory 24 of the device 10.

Also considered is where the processor(s) CPU are configured to review the compliance characteristic 14 including a version number of the device operating system 17 of the device 10, such that the version number of the device operating system 17 is compared with a corresponding version number associated with the security policy 204 to determine the current version of the operating system 17 as contrary to the corresponding version number and in response generate the compromised status indicator for the device 10. Also, the compliance characteristic 14 can be a confirmation by the first client application APP1 of jailbreak detection of the device 10 and the corresponding policy 204 provides at least one recommended remedial action 212 in response along with the generation of the compromised status indicator for sending to the other servers 20 as the notification message 206. Also, the compliance characteristic 14 can be confirmation by the first client application APP1 of root detection of the device 10 and the corresponding policy 204 provides at least one recommended remedial action 212 in response along with the generation of the compromised status indicator.

Further, the notification message 206 can be configured by the processor CPU to include one or more of a port number of the device 10, a network address of the device 10, a port number of the server 20, and a network address 208 of the server 20.

Also included is where the server 20 is configured as the notified server 20. In this case, the server 20 is configured for managing server access by one or more client applications APP2 of the device 10 over the communications network 11, the server 20 having a set of stored instructions for execution by a computer processor CPU to: receive the device status message 206 over the communications network 11 from a second server 20 (e.g. detection server 20) including the compromised (e.g. exploited) status indicator and identification data 201 uniquely identifying the device 10, the compromised (e.g. exploited) status indicator indicative of a current (e.g. exploited) state of the device 10 as contrary to a security policy 204 of the second server 20; and update in the storage 24 of the server a server access status of the device 10 with the server 20 in order to inhibit further server access by the device 10 with the server 20 until receipt of a restore status message 206 indicating the current state is in compliance with the security policy 204 of the second server 20.

### Example Storage 18,23

In view of the above descriptions of storage 24 for the computer devices 10,20 (see FIG. 1) can be configured as keeping the stored data (security policy 204, server address database 210) in order and the principal (or only) operations on the stored data are the addition/amendment of, processing of, or removal of the stored data from storage 24 (e.g. FIFO, FIAO, etc.). For example, storage 24 can be a linear data structure for containing and subsequent accessing of the stored data and/or can be a non-linear data structure for containing and subsequent accessing of the stored data.

Further, storage 24 receives various entities such as data that are stored and held to be processed later. In these contexts, storage 24 can perform the function of a buffer, which is a region of memory used to temporarily hold data while it is being moved from one place to another (i.e. between the between computer devices 10,20). Typically, the data is stored in the memory when moving the data between processes within/between one or more computers. It is recognised that storage 24 can be implemented in hardware, software, or a combination thereof. The storage 24 is used in the network system 8 when there is a difference between the rate/time at which data is received and the rate/time at which the data can be processed (e.g. ultimately by the devices 10,20).

Further, it will be understood by a person skilled in the art that memory/storage 24 described herein is the physical place where data can be held in an electromagnetic or optical form for access by the computer processors/modules. There can be two general usages: first, memory is frequently used to mean the devices and data connected to the computer through input/output operations such as hard disk and tape systems and other forms of storage not including computer memory and other in-computer storage such as flash memory. Second, in a more formal usage, memory/storage 24 has been divided into: (1) primary storage, which holds data in memory (sometimes called random access memory or RAM) and other “built-in” devices such as the processor's L1 cache, and (2) secondary storage, which holds data on hard disks, tapes, and other devices requiring input/output operations. Primary storage can be faster to access than secondary storage because of the proximity of the storage to the processor or because of the nature of the storage devices. On the other hand, secondary storage can hold much more data than primary storage. In addition to RAM, primary storage includes read-only memory (ROM), flash memory, and L1 and L2 cache memory. In addition to hard disks, secondary storage includes a range of device types and technologies, including diskettes, flash memory, Zip drives, redundant array of independent disks (RAID) systems, and holographic storage. Devices that hold storage are collectively known as storage media 24.

A database is one embodiment of memory 24 as a collection of information that is organized so that it can easily be accessed, managed, and updated. In one view, databases can be classified according to types of content: bibliographic, full-text, numeric, and images. In computing, databases are sometimes classified according to their organizational approach. The most prevalent approach is the relational database, a tabular database in which data is defined so that it can be reorganized and accessed in a number of different ways. A distributed database is one that can be dispersed or replicated among different points in a network. An object-oriented programming database is one that is congruent with the data defined in object classes and subclasses. Computer databases typically contain aggregations of data records or files, such as transactions, catalogs and inventories, and profiles. Typically, a database manager provides users the capabilities of controlling read/write access, specifying report generation, and analyzing usage. Databases and database managers are prevalent in large mainframe systems, but are also present in smaller distributed workstation and mid-range systems such as the AS/400 and on personal computers. SQL (Structured Query Language) is a standard language for making interactive queries from and updating a database such as IBM's DB2, Microsoft's Access, and database products from Oracle, Sybase, and Computer Associates.

Memory/storage 24 can also be defined as a physical electronic holding place for instructions and data that the computer's microprocessor can reach quickly. When the computer is in normal operation, its memory usually contains the main parts of the operating system and some or all of the application programs and related data that are being used. Memory is often used as a shorter synonym for random access memory (RAM) and/or flash memory. This kind of memory can be located on one or more microchips that are physically close to the microprocessor in the computer.

In terms of a server, it is recognised that the computer devices 20 can be configured as hardware, software, or typically a combination of both hardware and software to provide a network entity that operates as a socket listener. It is recognised that any computerised process that shares a resource (e.g. data) to one or more client processes can be classified as a server in the system 8. The term server can also be generalized to describe a host that is deployed to execute one or more such programs, such that the host can be one or more configured computers that link other computers or electronic devices together via the network 11. The computer devices 20 implementing functionality of the service can provide specialized services across the network 11 with applications 13,16 executed on the devices 10, for example to private users inside a large organization or to public users via the Internet 11. In the system 8, the servers 20 can have dedicated functionality and/or can share functionality as described. Enterprise servers 20 are servers that are used in a business context and can be run on/by any capable computer hardware. In the hardware sense, the word server 20 typically designates computer models intended for running software applications under the heavy demand of a network 11 environment. In this client-server configuration one or more machines, either a computer or a computer appliance, share information with each other with one acting as a host for the other. While nearly any personal computer is capable of acting as a network or application server 20, a dedicated server 20 can contain features making it more suitable for production environments. These features may include a faster CPU, increased high-performance RAM, and typically more than one large hard drive. More obvious distinctions include marked redundancy in power supplies, network connections, and even the servers themselves.

### Example of Computer Device 20

Referring to FIG. 3, a computing device 20 implementing functionality of the server 20 can include a network connection interface 111, such as a network interface card or a modem, coupled via connection 118 to a device infrastructure 114. The connection interface 111 is connectable during operation of the devices to the network 11 (e.g. an intranet and/or an extranet such as the Internet), which enables the devices to communicate with each other as appropriate. The network 11 can support the communication of the communications 29, 206, and the related content.

Referring again to FIG. 3, the device 20 can also have a user interface not shown, coupled to the device infrastructure 114, to interact with a user (e.g. server administrator—not shown). The user interface can include one or more user input devices such as but not limited to a QWERTY keyboard, a keypad, a stylus, a mouse, a microphone and the user output device such as an LCD screen display and/or a speaker. If the screen is touch sensitive, then the display can also be used as the user input device as controlled by the device infrastructure.

Referring again to FIG. 3, operation of the device 20 is facilitated by the device infrastructure 114. The device infrastructure 114 includes one or more computer processors CPU and can include an associated memory 24. The computer processor CPU facilitates performance of the device 20 configured for the intended task (e.g. of the respective module(s)) through operation of the network interface 111, the user interface and other application programs/hardware 26 of the device 20 by executing task related instructions. These task related instructions can be provided by an operating system, and/or software applications located in the memory 24, and/or by operability that is configured into the electronic/digital circuitry of the processor(s) CPU designed to perform the specific task(s). Further, it is recognized that the device infrastructure 114 can include a computer readable storage medium coupled to the processor CPU for providing instructions to the processor CPU and/or to load/update the instructions (e.g. application 26). The computer readable medium can include hardware and/or software such as, by way of example only, magnetic disks, magnetic tape, optically readable medium such as CD/DVD ROMS, and memory cards. In each case, the computer readable medium may take the form of a small disk, floppy diskette, cassette, hard disk drive, solid-state memory card, or RAM provided in the memory module. It should be noted that the above listed example computer readable mediums can be used either alone or in combination.

Further, it is recognized that the computing device 20 can include the executable applications comprising code or machine readable instructions for implementing predetermined functions/operations including those of an operating system and the modules, for example. The processor CPU as used herein is a configured device and/or set of machine-readable instructions for performing operations as described by example above, including those operations as performed by any or all of the modules. As used herein, the processor CPU may comprise any one or combination of, hardware, firmware, and/or software. The processor CPU acts upon information by manipulating, analyzing, modifying, converting or transmitting information for use by an executable procedure or an information device, and/or by routing the information with respect to an output device. The processor CPU may use or comprise the capabilities of a controller or microprocessor, for example. Accordingly, any of the functionality of the modules may be implemented in hardware, software or a combination of both. Accordingly, the use of a processor CPU as a device and/or as a set of machine-readable instructions is referred to generically as a processor/module for sake of simplicity. Further, it is recognised that the server 20 can include one or more of the computing devices (comprising hardware and/or software) for implementing the processor(s) CPU, as desired.

It will be understood in view of the above that the computing devices 20 may be, although depicted as a single computer system, may be implemented as a network of computer processors CPU, as desired.

1. A server configured for managing server access by a first client application of a device over a communications network, the server having a set of stored instructions for execution by a computer processor to:
receive a status message from the first client application over the communications network, the first client application managed by the server, the message including at least one compliance characteristic associated with a security policy of the server and an unique identification of the device;
access the security policy and compare the at least one compliance characteristic with a corresponding policy of the security policy to determine a current state of the device as contrary to the corresponding policy and in response generate a compromised status indicator for the device;
access a storage to obtain a network address associated with a second server managing a second client application of the device; and
send a device status message to the network address of the second server including the compromised status indicator and identification data uniquely identifying the device to the second server.

2. The server of claim 1 further configured to update in the storage a server access status of the device with the server in order to inhibit further server access by the device with the server until receipt of a restore status message indicating the at least one compliance characteristic is in compliance with the corresponding policy.

3. The server of claim 2 further configured to, in combination with updating the server access status, send an alert message to a system administrator.

4. The server of claim 2 further configured to, in combination with updating the server access status, send a server command message to the device to affect operation of the device.

5. The enterprise server of claim 4, wherein the server command message includes a command selected from the group consisting of: locking overall operation of the device; locking operation of the first client application; locking operation of another client application of the device also managed by the server; deleting all operational memory of the device; deleting the first client application from operational memory of the device; deleting the first client application and any other one or more client applications also managed by the server from operational memory of the device.

6. The server of claim 1, wherein the compliance characteristic includes a version number of the device operating system of the device, such that the version number of the device operating system is compared with a corresponding version number associated with the security policy to determine the current version of the operating system as contrary to the corresponding version number and in response generate the compromised status indicator for the device.

7. The server of claim 1, wherein the at least one compliance characteristic is a confirmation by the first client application of jailbreak detection of the device and the corresponding policy provides at least one recommended remedial action in response along with the generation of the compromised status indicator.

8. The server of claim 1, wherein the at least one compliance characteristic is a confirmation by the first client application of root detection of the device and the corresponding policy provides at least one recommended remedial action in response along with the generation of the compromised status indicator.

9. The server of claim 1, wherein the device is a device selected from the group consisting of: a wireless device; a handheld device; a tablet; and a laptop.

10. The server of claim 1, wherein the communications network is a combination at least one intranet and at least one extranet.

11. The server of claim 1, wherein the at least one compliance characteristic indicates existence of an unauthorized directory path in a file system of the device.

12. The server of claim 1, wherein the at least one compliance characteristic indicates existence of an unauthorized directory permission for a predefined directory.

13. The server of claim 1, wherein the at least one compliance characteristic indicates existence of an unauthorized file permission for a predefined file.

14. The server of claim 13, wherein the unauthorized file permission is a write permission.

15. The server of claim 1, wherein the at least one compliance characteristic indicates existence of unauthorized process forking.

16. The server of claim 1, wherein the at least one compliance characteristic indicates existence of configuration of the mobile to enable unauthorized connections to predefined network server addresses on predefined server ports.

17. The server of claim 1, wherein the at least one compliance characteristic indicates existence of improper return data for a predefined function call.

18. The server of claim 1, wherein the storage is a device compliance database having a device record containing the unique identification of the device linked to the network address of the second server.

19. The server of claim 18, wherein the device compliance database has a plurality of device records each having a respective device linked to a respective second server.

20. The server of claim 1, wherein the unique identification of the device is a MAC address and the network address associated with the second server is an IP address.

21. The server of claim 1, wherein the first client application is configured as a client application of the server and the operating system status message further includes a port number of the device, a network address of the device, a port number of the server, and a network address of the server.

22. A server configured for managing server access by one or more client applications of a device over a communications network, the server having a set of stored instructions for execution by a computer processor to:
receive a device status message over the communications network from a second server including a compromised status indicator and identification data uniquely identifying the device, the compromised status indicator indicative of a current state of the device as contrary to a security policy of the second server; and
update in a storage a server access status of the device with the server in order to inhibit further server access by the device with the server until receipt of a restore status message indicating the current state is in compliance with the security policy.

23. The server of claim 22 further configured to:
access the storage to obtain a network address associated with a third server managing another client application of the device; and
send a device status message to the network address of the third server including the compromised status indicator and identification data uniquely identifying the device to the third server.

24. The server of claim 22, wherein the device status message is obtained directly from a network address of the second server.

25. The server of claim 22 further configured to, in combination with updating the server access status, send an alert message to a system administrator.

26. The server of claim 22 further configured to, in combination with updating the server access status, send a server command message to the device to affect operation of the device.

27. The server of claim 22, wherein the compromised status indicator includes a version number of the device operating system of the device, such that the version number of the device operating system is compared with a corresponding version number associated with a security policy of the enterprise server to determine the current version of the operating system as contrary to the corresponding version number.

28. The server of claim 22, wherein the compromised status indicator is a confirmation of jailbreak detection of the device and a corresponding policy of the enterprise server provides at least one recommended remedial action in response.

29. The server of claim 22, wherein the compromised status indicator is a confirmation of root detection of the device and a corresponding policy of the enterprise server provides at least one recommended remedial action in response.

29. The server of claim 28 or 29, wherein the remedial action is to send a server command message to the device to affect operation of the device.

30. The server of claim 22, wherein the compromised status indicator includes information on at least one compliance characteristic associated with a security policy of the second enterprise server, such that the at least one compliance characteristic is a basis upon which the device status message was sent to the server.
